(19) United States
(12) Patent Application Publication
(10) Pub. No.: US 2008/0277822 A1
(43) Pub. Date: Nov. 13, 2008

(54) APPARATUS AND METHOD FOR PERIODICALLY COOLING INJECTION MOLD

(76) Inventors: Chih-Yu CHEN, Tu-Cheng City (TW); Jian-Ren Wang, Tu-Cheng City (TW); Ke-Meng He, Tu-Cheng City (TW)

Correspondence Address: BIRCH STEWART KOLASCH & BIRCH, PO BOX 747, FALLS CHURCH, VA, 22040-0747, US

(21) Appl. No.: 11/746,612

(22) Filed: May 9, 2007

(51) Int. Cl. B29C 45/73; B29C 45/03

(52) U.S. Cl. 264/237; 425/556

(57) ABSTRACT

An apparatus for periodically cooling injection mold has a cavity formed between a cavity insert and a core insert of the injection mold. The bottom of the cavity defines a perforation that extends and passes through a lower pushing plate. An ejector pin is received in the perforation. The bottom end of the ejector pin passes out of the lower pushing plate and is above the top surface of a lower fixed plate. A sensor switch that controls several electric valve actuators is located on the lower fixed plate and is below the ejector pin. The electric valve actuators control cooling liquid to flow into several cooling pipes that are configured in the cavity insert and the core insert respectively. A method for periodically cooling injection mold includes the steps of: closing the injection mold and pouring raw materials into the cavity to form a product; pushing the ejector pin downward along the perforation and the bottom of the ejector pin touching and pressing the sensor switch. The sensor switch is inducted, and further causes the electric valve actuators opened. The cooling liquid flows into the cooling pipes for cooling the injection mold. Then, liberate the bottom of the ejector pin away from the sensor switch when the product is taken out from the injection mold. Last, release induction of the sensor switch for causing the electric valve actuator closed correspondingly and for stopping the cooling liquid into the cooling pipes.

### BACKGROUND OF THE INVENTION

1. Field of the Invention

The present invention relates to an injection mold, and more particularly to an apparatus and method for periodically cooling the injection mold.

2. The Related Art

For obtaining a product having designed shape, many raw materials are poured into a cavity of an injection mold. In the process of the product shaped, the temperature of the injection mold is increased. Conventionally, the injection mold arranges several water pipes therein to decrease the temperature. The water pipes are filled with cooling water, and the cooling water moves in circles in the water pipes so as to decrease the temperature of the injection mold. However, the switch of the water pipes is arranged out of the injection mold. Hence, the cooling water is injected in the water pipes continually and flows in the water pipes all the time till somebody closes the switch. As a result, it causes the resource of water to be wasted, and further causes the temperature of the interior of the injection mold to lose equilibrium. It influences the quality of the product badly.

### SUMMARY OF THE INVENTION

Accordingly, an object of the present invention is to provide an apparatus for periodically cooling injection mold, The apparatus includes a lower fixed plate, a plurality of supporting blocks mounted on the lower fixed plate, a pair of pushing plates located between the supporting blocks, a male mold arranged on the supporting blocks and a core insert defined therein, a female mold coupled with the male mold and a cavity insert defined therein, an upper fixed plate mounted on the female mold, and a plurality of cooling pipes arranged in the cavity insert and the core insert respectively. Wherein a cavity is formed between the cavity insert and the core insert. The bottom of the cavity defines a perforation that passes through the core insert, the male mold, the upper pushing plate and the lower pushing plate. An ejector pin is received in the perforation. The bottom end of the ejector pin passes out of the lower pushing plate and is above the top surface of the lower fixed plate. A sensor switch that controls several electric valve actuators is located on the lower fixed plate and is below the ejector pin. The electric valve actuators control cooling liquid to flow in the cooling pipes.

The other object of the present invention is to provide a method for periodically cooling injection mold. The method includes the steps of: closing the injection mold and pouring raw materials into the cavity to form a product; pushing the ejector pin downward along the perforation and the bottom end of the ejector pin touching and pressing the sensor switch. The sensor switch is inducted, and further causes the electric valve actuators to be opened. The cooling liquid flows into the cooling pipes for cooling the injection mold. Then, liberate the bottom end of the ejector pin away from the sensor switch when the product is taken out from the injection mold. Last, release induction of the sensor switch for causing the electric valve actuators closed. The cooling liquid is stopped flowing into the cooling pipes.

The design of the apparatus and method for periodically cooling the injection mold economizes the cooling liquid and the temperature of the interior of the injection mold is even cooling. It improves the quality of the product.

### BRIEF DESCRIPTION OF THE DRAWINGS

The present invention will be apparent to those skilled in the art by reading the following description of a preferred embodiment thereof, with reference to the attached drawings, in which:

FIG. 1 is a cross-sectional view of an injection mold with a cooling apparatus in accord with the present invention;

FIG. 2 is a partially enlarged view of the encircled portion labeled II shown in FIG. 1;

FIG. 3 is a partially enlarged view of the encircled portion labeled III shown in FIG. 1;

FIG. 4 is a cross-sectional view illustrating the injection mold when a product is formed therein;

FIG. 5 is a cross-sectional view showing a female mold and a male mold of the present invention departed form each other; and

FIG. 6 is a cross-sectional view showing the product to be ejected form the injection mold.

### DETAILED DESCRIPTION OF THE PREFERRED EMBODIMENT

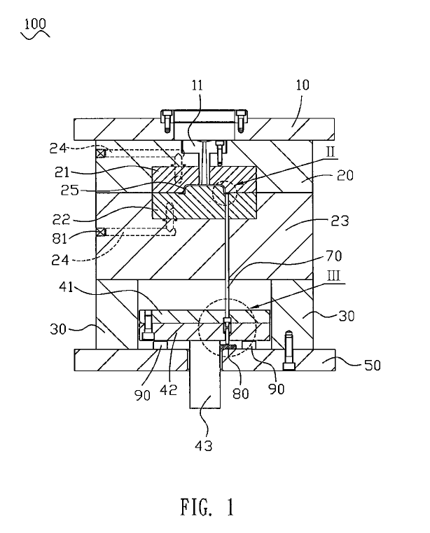

Referring to FIG. 1, an injection mold 100 according to the present invention includes a lower fixed plate 50, a plurality of supporting blocks 30 mounted on the lower fixed plate 50, a pair of pushing plates located between the supporting blocks 30 and designating a lower pushing plate 42 and an upper pushing plate 41, a male mold 23 arranged on the supporting blocks 30 and a core insert 22 defined therein, a female mold 20 coupled with the male mold 23 and a cavity insert 21 defined therein too, and an upper fixed plate 10 mounted on the female mold 20.

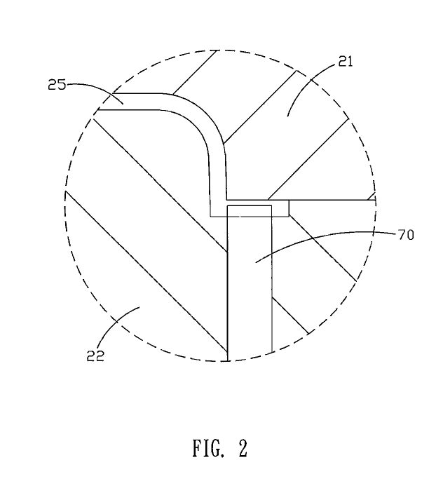

Please refer to FIGS. 1-3. A plurality of cooling pipes 24 are arranged from outside to the inner of the female mold 20 and the male mold 23 respectively and further extend into the cavity insert 21 and the core insert 22. The upper fixed plate 10 defines a T-shaped nozzle 11 at its middle. The nozzle 11 has a funnel-shaped passage that extends to a cavity 25 defined between the cavity insert 21 and the core insert 22 for forming a product. The bottom of the cavity 25 defines a perforation (not shown) that passes through the core insert 22, the male mold 23, and the upper pushing plate 41 as well as the lower pushing plate 42. An ejector pin 70 is received in the perforation. The top end of the ejector pin 70 stretches out of the perforation a bit and is received in the cavity 25. The bottom end of the ejector pin 70 passes out of the lower pushing plate 42 and is above the top surface of the lower fixed plate 50. A sensor switch 80 that controls a pair of electric valve actuators 81 is located on the lower fixed plate 50 and is below the ejector pin 70. The electric valve actuator 81 is configured at the entrance of the cooling pipe 24 to the inner of the injection mold 100 and controls cooling liquid to flow into the cooling pipe 24. The length of the ejector pin 70 that is received in the cavity 25 is longer than the distance that is between the sensor switch 80 and the bottom surface of the ejector pin 70 in the condition that the injection mold 100 is in close state. A pair of pedestals 90 is defined on the lower fixed plate 50 and is distributed at both sides of the sensor switch 80. The height of the pedestal 90 is higher than the height of the sensor switch 80 to protect the sensor switch 80 from being damaged by the lower pushing plate 42 when the lower pushing plate 42 moves downward. The upper pushing plate 41 and the lower pushing plate 42 are fixed together via a plurality of screws or the like, and the lower pushing plate 42 extends downward to form an ejector rod 43. The ejector rod 43 perforates through the lower fixed plate 50 and is exposed outside.

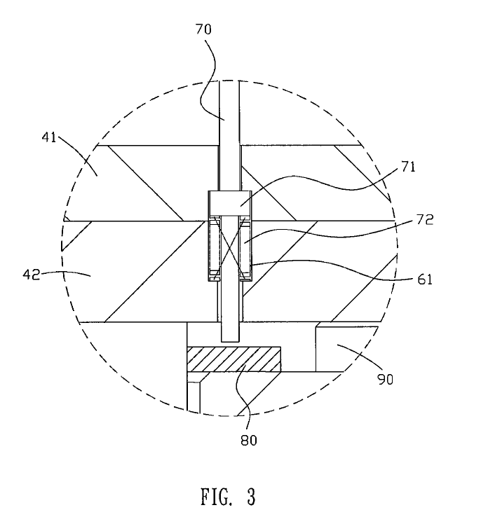

Please refer to FIG. 3 again. The perforation that is between the upper pushing plate 41 and the lower pushing plate 42 extends outward to form a column-shaped receiving cavity 61. The ejector pin 70 that is received in the receiving cavity 61 protrudes outward to form a flange 71, and the flange 71 is locked at the top portion of the receiving cavity 61. Between the bottom of the flange 71 and the bottom of the receiving cavity 61, a plurality of springs 72 is put around the ejector pin 70.

The method for periodically cooling the injection mold 100 is described hereinafter.

As showing in FIG. 1, the injection mold 100 is in close state. The elastic force of the springs 72 makes the flange 71 of the ejector pin 70 to be locked at the top portion of the receiving cavity 61 of the perforation. So the bottom of the ejector pin 70 keeps a distance from the sensor switch 80, and now the sensor switch 80 is not inducted. Hence, the electric valve actuators 81 are close and the cooling liquid can't flow into the cooling pipes 24.

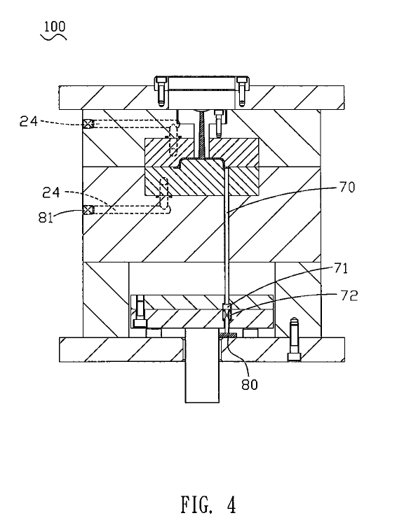

Referring to FIG. 4, after raw materials are poured into the cavity 25 to form the product, the temperature of the injection mold 100 increases. The pressure from the product acting on the ejector pin 70 is greater than the elastic force of the springs 72 acting on the flange 71 of the ejector pin 70. The springs 72 are compressed. Therefore, the ejector pin 70 is compelled to move downward and the bottom end of the ejector pin 70 touches and presses the sensor switch 80. The sensor switch 80 is inducted, and further causes the electric valve actuators 81 opened. Then the cooling liquid flows into the cooling pipes 24 periodically to decrease the temperature of the injection mold 100.

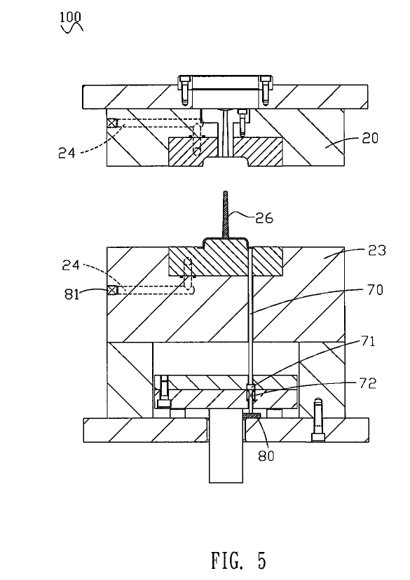

Please refer to FIG. 5. When the injection mold 100 is opened, the female mold 20 is departed from the male mold 23. At this time, the temperature of the injection mold 100 is still high. But the stored elastic force of the springs 72 is not great enough to push the flange 71 of the ejector pin 70 to remove upward. So the ejector pin 70 still acts on the sensor switch 80, and the sensor switch 80 is continually inducted. The electric valve actuators 81 are correspondingly open. The cooling liquid flows into the cooling pipes 24 periodically to decrease the temperature of the injection mold 100 continually. Then the injection mold 100 is cooled adequately.

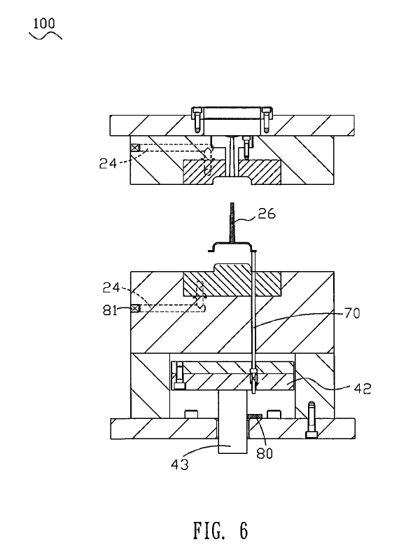

Referring to FIG. 6, in order to obtain the product, the ejector rod 43 pushes the lower pushing plate 42 upward and further brings the ejector pin 70 to remove upward. Then the product is ejected out from the injection mold 100. The ejector pin 70 is removed away form the sensor switch 80 and the induction of the sensor switch 80 is released, and further causes the electric valve actuators 81 closed. The cooling liquid is stopped flowing into the cooling pipes 24. Subsequently, the upper pushing plate 41 and the lower pushing plate 42 move downward, and bring the ejector pin 70 to move downward too. The flange 71 is locked at the top portion of the receiving cavity 61 under the action of the springs 72.

As described above, when the product is formed, the ejector pin 70 is pushed downward, and the bottom end of the ejector pin 70 touches and presses the sensor switch 80. The sensor switch 80 is inducted, and further causes the electric valve actuators 81 opened, and the cooling liquid flows into the cooling pipes 24 to decrease the temperature of the injection mold 100. Until the product is ejected out from the injection mold 100, the ejector pin 70 removes away from the sensor switch 80. The induction of the sensor switch 80 is released, and further causes the electric valve actuators 81 closed correspondingly. The cooling liquid is stopped flowing into the cooling pipes 24. The design of the apparatus and method for periodically cooling the injection mold 100 economizes the cooling liquid and the temperature of the interior of the injection mold 100 is even cooling. It improves the quality of the product.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An apparatus for periodically cooling injection mold, comprising:
a lower fixed plate;
a plurality of supporting blocks mounted on the lower fixed plate;
a pair of pushing plates located between the supporting blocks;
a male mold arranged on the supporting blocks and a core insert defined therein;
a female mold coupled with the male mold and a cavity insert defined therein;
an upper fixed plate mounted on the female mold; and
a plurality of cooling pipes arranged in the cavity insert and the core insert respectively;
wherein a cavity is formed between the cavity insert and the core insert, the bottom of the cavity defines a perforation that passes through the core insert, the male mold, the upper pushing plate and the lower pushing plate, an ejector pin is received in the perforation, the bottom end of the ejector pin passing out of the lower pushing plate and being above the top surface of the lower fixed plate, a sensor switch that controls several electric valve actuators is located on the lower fixed plate and being below the ejector pin, the electric valve actuators control cooling liquid to flow into the cooling pipes.

2. The apparatus for periodically cooling injection mold as claimed in claim 1, wherein a pair of pedestals is defined on the lower fixed plate and distributed at both sides of the sensor switch, and the height of the pedestal is higher than the height of the sensor switch.

3. The apparatus for periodically cooling injection mold as claimed in claim 1, wherein the top end of the ejector pin stretches out of the perforation a bit and is received in the cavity, the length of the ejector pin that is received in the cavity is longer than the distance that is between the sensor switch and the bottom surface of the ejector pin in the condition that the injection mold is in close state.

4. The apparatus for periodically cooling injection mold as claimed in claim 1, wherein the perforation that is between the upper pushing plate and the lower pushing plate extends outward to form a receiving cavity, the ejector pin that is received in the receiving cavity protrudes outward to form a flange, and the flange locked at the top portion of the receiving cavity, between the bottom of the flange and the bottom of the receiving cavity, a plurality of springs is put around the ejector pin.

5. A method for periodically cooling injection mold, comprising the steps of:
closing the injection mold and pouring raw materials into the cavity to form a product;
pushing the ejector pin downward along the perforation and the bottom of the ejector pin for touching and pressing the sensor switch, then the sensor switch being inducted, and further causing the electric valve actuators opened, cooling liquid flowing into the cooling pipes for cooling the injection mold;
liberating the bottom end of the ejector pin away from the sensor switch when the product is taken out from the injection mold; and
releasing induction of the sensor switch for causing the electric valve actuators closed correspondingly and for stopping the cooling liquid into the cooling pipes.

6. The method for periodically cooling injection mold as claimed in claim 5, wherein after the product formed in the cavity, the female mold is departed from the male mold, before the product ejected out from the cavity, the ejector pin still presses the sensor switch, and the sensor switch is continually inducted, the electric valve actuators are still in open state, and the cooling liquid continually flows into the cooling pipes to cool the injection mold.

7. The method for periodically cooling injection mold as claimed in claim 5, wherein the force to push the ejector pin comes from the force forming in the process of injection molding.
